(19) United States
(12) Patent Application Publication
(10) Pub. No.: US 2025/0042340 A1
(43) Pub. Date: Feb. 6, 2025

(54) ON-RACK SKI SEPARATOR AND VEHICLE SPORTS RACK WITH SKI SEPARATOR

(71) Applicants: Charles Blake Owen, Alpine, UT (US); BRYCE ALLEN OWEN, HIGHLAND, UT (US)

(72) Inventors: Charles Blake Owen, Alpine, UT (US); BRYCE ALLEN OWEN, HIGHLAND, UT (US)

(73) Assignee: East Mountain Outfitters LLC, Lehi, UT (US)

(21) Appl. No.: 18/746,391

(22) Filed: Jun. 18, 2024

Related U.S. Application Data
(60) Provisional application No. 63/517,156, filed on Aug. 2, 2023.

(51) Int. Cl. B60R 9/06; B60R 9/10; B60R 9/12

(52) U.S. Cl. CPC B60R 9/06; B60R 9/10; B60R 9/12

(57) ABSTRACT

A vehicle sports rack includes a ski and/or snowboard support beam with an edge support for skis, according to an embodiment.

### CROSS REFERENCE TO RELATED APPLICATION

The present application claims priority benefit from U.S. Provisional Patent Application Ser. No. 63/517,156 (docket number 3065-003-02), entitled “ON-RACK SKI SEPARATOR AND VEHICLE SPORTS RACK WITH SKI SEPARATOR,” filed Aug. 2, 2023.

The foregoing application, to the extent not inconsistent with the disclosure herein, is incorporated herein by reference.

### SUMMARY

According to an embodiment, as part of a sports rack for a vehicle, a ski and snowboard mount includes a beam supported by a vehicle rack structure. The beam has a support surface configured to support a surface of at least one ski or snowboard. An edge support extends away from the beam support surface to protrude adjacent to an edge of the at least one ski to prevent the at least one ski from translating sideways along the support surface of the beam.

According to an embodiment, a method for coupling at least one ski with a support surface of a support beam to a vehicle rack for transport of the at least one ski includes placing at least one ski against a support surface of a support beam. An edge support is arranged at a substantially right angle to the beam support surface such that the edge support is adjacent to an edge of the at least one ski. The method includes fastening a keeper to hold the at least one ski against the beam support surface while the vehicle is driven. The edge support is configured to prevent the at least one ski from sliding sideways along the beam support surface.

### BRIEF DESCRIPTION OF THE DRAWINGS

FIG. 1 is a perspective view of a vehicle sports rack, according to an embodiment.

FIG. 2 is an illustration of a vehicle sports rack coupled to a vehicle and carrying a bicycle, according to an embodiment.

FIG. 3 is a diagram showing an upper assembly with support beam including an edge support, according to an embodiment.

FIG. 4 is a diagram showing a lower assembly with a support beam and edge support with an additional clamp beam configured to hold a different portion of at least one ski against a support surface of the support beam, according to an embodiment.

FIG. 5 is a diagram of a tow bar-mounted vehicle rack including support beams for carrying at least one ski on a vehicle during transit, according to an embodiment.

FIG. 6 is a top view of the tow bar-mounted vehicle rack of FIG. 5, according to an embodiment.

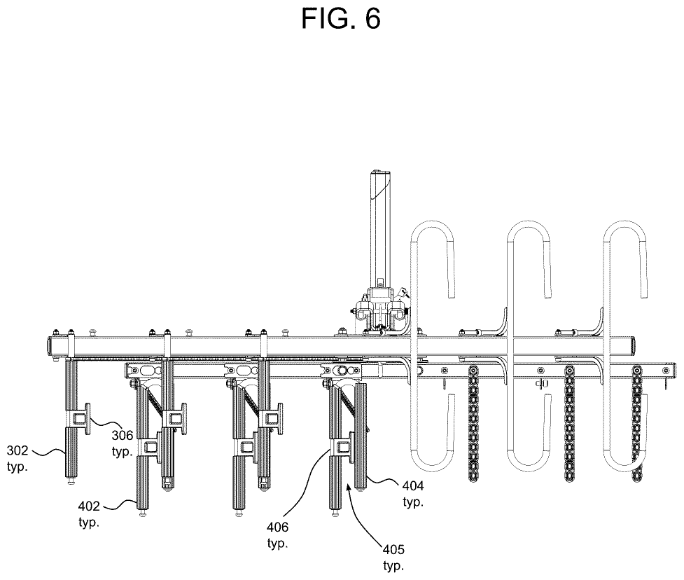

FIG. 7 includes views of the tow bar mounted vehicle rack of FIGS. 5 and 6 with skis mounted thereon, according to an embodiment.

FIG. 8 is another view of the tow bar-mounted vehicle rack of FIG. 7 with skis mounted thereon, according to an embodiment.

FIG. 9 is a view of the tow bar-mounted vehicle rack of FIG. 8 from a different angle, according to an embodiment.

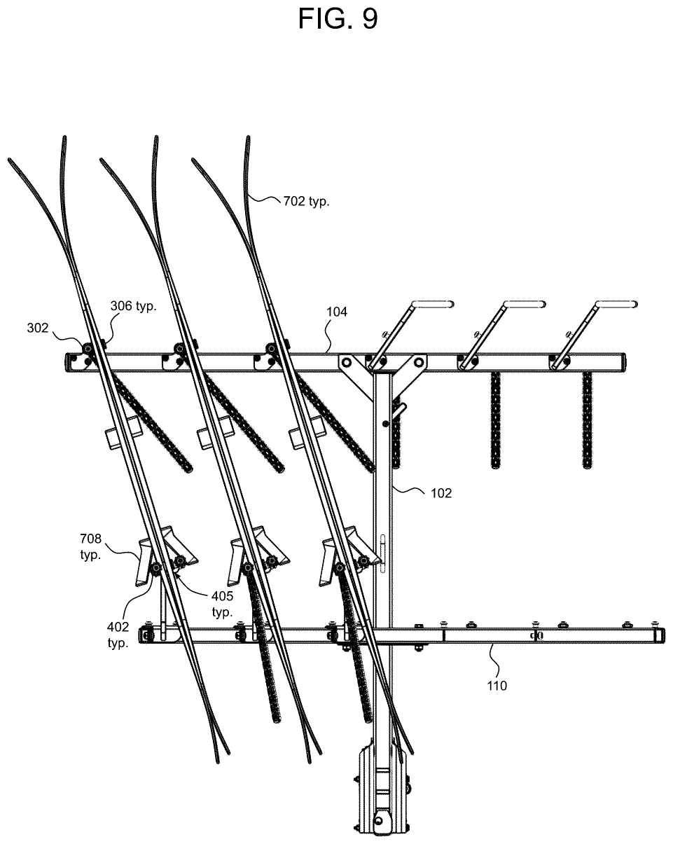

FIG. 10 is a view of the tow bar-mounted sports rack of the preceding figures with snowboards mounted thereon, according to an embodiment.

FIG. 11 is view of the tow bar-mounted sports rack of the preceding figures with a mix of skis, snowboards and bicycles mounted thereon, according to an embodiment.

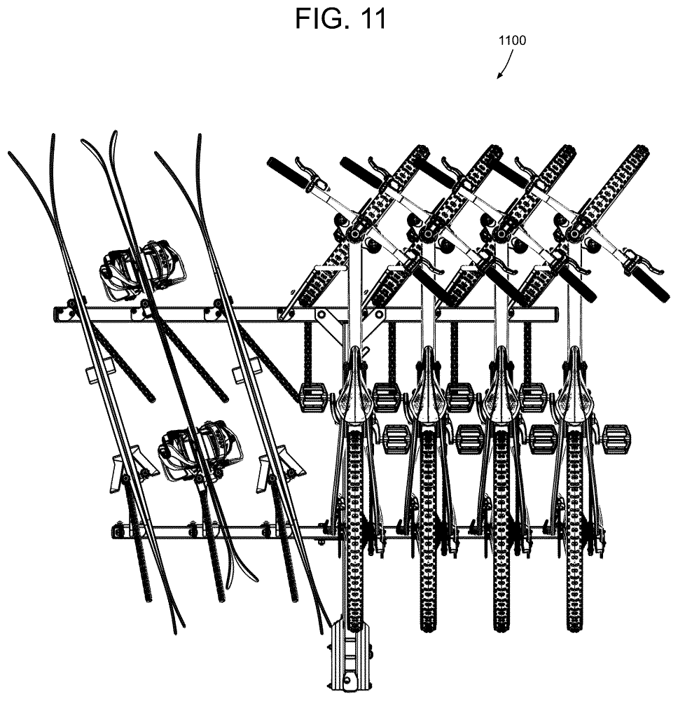

FIG. 12 is view of the tow bar-mounted sports rack of the preceding figures with a different mix of skis and a bicycle rack mounted thereon, according to an embodiment.

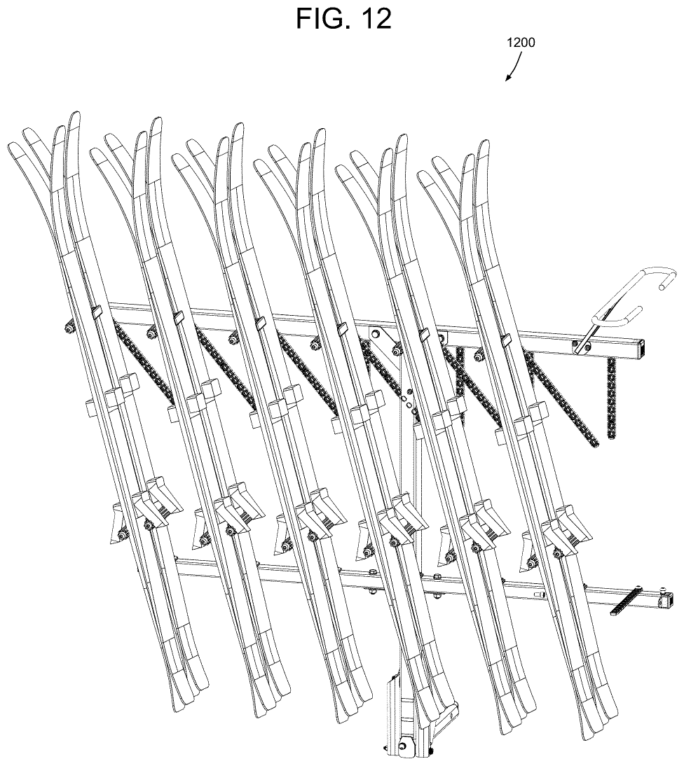

FIG. 13 is a flow chart showing a method for coupling at least one ski with a support surface of a support beam to a vehicle rack for transport of the at least one ski, according to an embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description and drawings are not meant to be limiting. Other embodiments may be utilized, and other changes may be made, without departing from the spirit or scope of the subject matter presented herein.

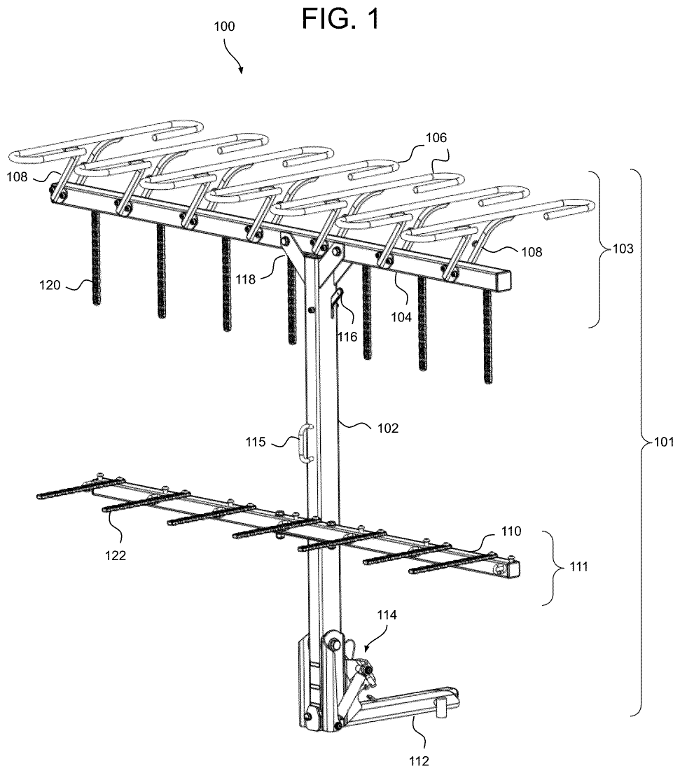

FIG. 1 is a perspective view of a vehicle sports rack 100, according to an embodiment. As used herein, the terms sports rack, vehicle sports rack, sports equipment rack, ski rack, and the like are used interchangeably. Unless context dictates otherwise, the terms should be considered synonymous.

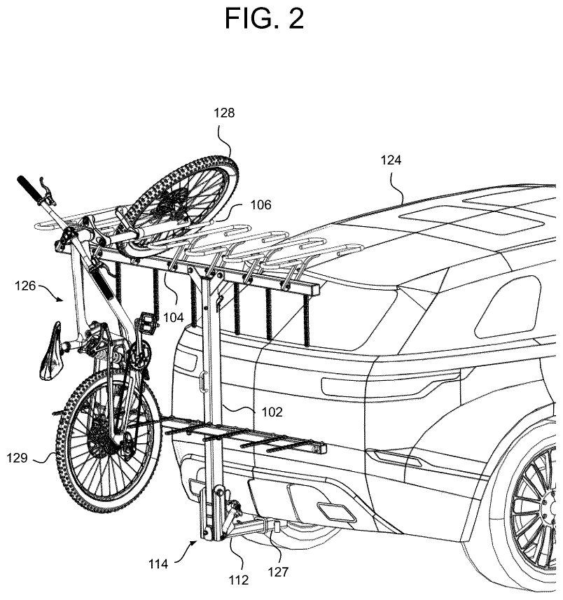

While the present application is concerned primarily with a vehicle ski and snowboard rack and features thereof, according to embodiments, description corresponding to FIGS. 1 and 2 will begin with focus on a vehicle sports rack with bicycle mounting features. Portions of this initial description in common with the ski and snowboard carrying function, i.e., rack structures upon which ski carrying features are mounted, apply more generally, according to embodiments.

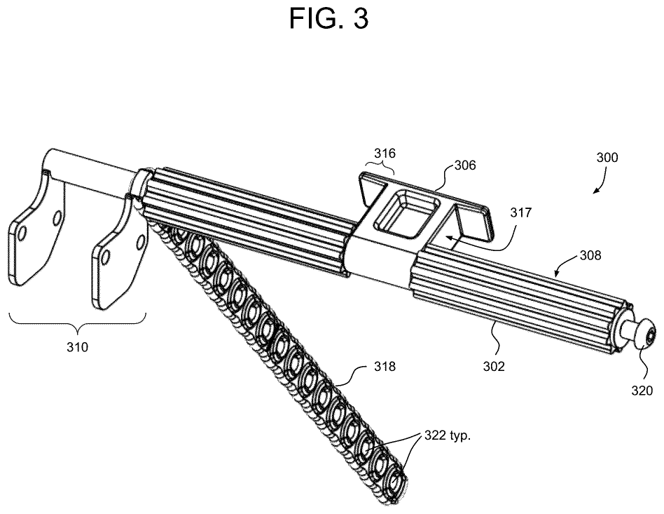

According to embodiments, the vehicle sports rack 100 includes a rack structure 101. The rack structure 101 includes a post 102, an upper equipment mount 103, a lower equipment mount 111, a hitch bar 112, and a hinge assembly 114 that rotatably couples the hitch bar 112 to the post 102. In an embodiment, the upper equipment mount 103 includes an upper horizontal support member 104, bicycle wheel C-hoops 106 configured to receive and hold bicycle wheels with angled support members 108, and a lower horizontal support member 110. As will be appreciated by reference beginning with FIG. 3 below, ski and snowboard mounting features may be mounted on the upper and lower horizontal support members 104, 110 in addition to or in place of some or all of the bicycle mounting features 106, 108, 122, etc. The post 102 and/or equipment mount 103 may optionally include a cable lock loop 115 configured to receive one or more locking cables or chains for securing sports equipment to the vehicle sports rack 100.

In the view of FIG. 1, the vehicle sports rack 100 is in a raised position for transport. As used herein, the terms raised position and transport position will be understood as synonymous unless context dictates otherwise. In the transport position the hinge assembly 114 holds the post 102 at a position substantially perpendicular to the hitch bar 112. The hitch bar 112 is configured to be placed in and fixed to a trailer hitch receiver 127 (see FIG. 2) of a vehicle 124 (see FIG. 2). In the transport position, the vehicle sports rack 100 can safely carry a plurality of bicycles 126 (see FIG. 2) while coupled to a moving vehicle 124 (see FIG. 2).

Each C-hoop 106 is configured to receive a front wheel 128 of a bicycle 126. The front wheel 128 of a bicycle 126 can be positioned, lowered into, or rolled into, a C-hoop 106. After being positioned in a C-hoop 106, the wheel 128 of the bicycle comes to rest at an angle other than vertical. The wheel of the bicycle 126 rests against the angled support members 108 and on the upper horizontal support member 104. The bicycle 126 is suspended vertically when the wheel is positioned in the C-hoop 106. This is illustrated in FIG. 2 and elsewhere in the figures. The angled support members 108 may be coupled to the upper horizontal support member 104 by bolts, welds, or other coupling devices or methods.

Each C-hoop 106 is coupled to the upper horizontal support member 104 by one or more angled support members 108. In the example of FIG. 1, the angled support members 108 extend from the upper horizontal support member 104 at an angle other than vertical. In one embodiment, the support angled members 108 extend at an angle of about 55° from horizontal. In this case, the wheel 128 of the bicycle 126 will rest in a C-hoop 106 at an angle of about 45° from horizontal, as shown in FIG. 2. Those of skill in the art will recognize, in light of the present disclosure, that other angles are possible without departing from the scope of the present disclosure.

In one embodiment, the post 102 is about 48 inches in length. The post 102 can have width dimensions of about 2 inches by 3 inches. The upper horizontal support member 104 is about 68 inches in length. The upper horizontal support member 104 has width dimensions of about 2 inches by 2 inches. The lower horizontal support member 110 has a length of about 64 inches. The lower horizontal support member 110 has width dimensions of about 1.75 inches by 1.75 inches. The hitch bar 112 has a length of about 20 inches, with width dimensions of about 2 inches by 2 inches. In one embodiment, the post 102, the upper horizontal support member 104, the lower horizontal support member 110, and the hitch bar 112 are each made of steel. Those of skill in the art will recognize, in light of the present disclosure, that dimensions and materials described herein are given by way of example and that other suitable dimensions and materials can be utilized without departing from the scope of the present disclosure.

In one embodiment, the upper horizontal support member 104 is coupled to the post 102 by mounting tabs 118. The mounting tabs 118 can include steel and can be fixed to the upper horizontal support member 104 by bolts, by welding, or by other fasteners or methods. The mounting tabs 118 can be fixed to the post 102 by welding, bolts, or by other fasteners or methods.

In one embodiment, the post 102 includes a release lever 116. Pulling the release lever 116 enables the post 102 to be rotated relative to the hitch bar 112 via the hinge assembly 114. The post 102 can be rotated between various stopping positions.

In one embodiment, the vehicle sports rack 100 includes a plurality of first straps 120 each coupled to the first horizontal support member 104. There is a first strap 120 for each C-hoop 106. When a bicycle wheel 128 (see FIG. 2) is placed in a C-hoop 106, the corresponding first strap 120 is looped around the wheel between two of the spokes and is fastened to a strap anchor on one of the angled support members 108. This can keep the wheel from moving or shifting when positioned in the C-hoop 106.

In one embodiment, the vehicle sports rack 100 includes a plurality of second straps 122 each coupled to the lower horizontal support member 110. There is a second strap 122 for each C-hoop 106. When a bicycle 126 (see FIG. 2) suspended from a C-hoop 106 by placing the wheel in the C-hoop 106, the bicycle 126 (see FIG. 2) will be suspended vertically, and the rear wheel will be in contact with the lower horizontal support member 110. The second strap 122 can be looped between two spokes on the rear wheel and connected to a fastener positioned on the lower horizontal support member 110. This will keep the rear wheel from shifting relative to the lower horizontal support member 110 during transport. Those of skill in the art will recognize, in light of the present disclosure, that other fastening methods can be used to secure the bicycle 126 (see FIG. 2) suspended from one of the C-hoops 106.

The word “vertical” in the term post 102 refers to the position of the post 102 when in the transport configuration. The transport configuration corresponds to the configuration in which the vehicle sports rack 100 is coupled to a vehicle 124, is carrying one or more bicycles 126, and is actively being transported, as shown in FIG. 2. In this case, the post 102 is substantially perpendicular to the hitch bar 112 and extends substantially vertically relative to flat ground. Those of skill in the art will recognize, that the post 102 can be rotated to positions other than vertical. Additionally, the vehicle sports rack 100 can be laid in positions in which the post 102 would not extend in a vertical direction. Accordingly, the word “vertical” in the term post 102 refers to the orientation of the post 102 in a particular transport configuration. Similarly, the word “horizontal” in the terms upper and lower horizontal support member 104, 110, refers to the orientation of the support member 104, 110 during the transport configuration. The vehicle sports rack 100 could be laid in positions in which the first and the second horizontal support members 104, 110 would not extend in the horizontal direction. In one embodiment, the vehicle sports rack 100 can include a post 102 that is not necessarily vertical in the transporting position. Additionally, the vehicle sports rack 100 can include upper and lower support members 104, 110 that are not horizontal.

FIG. 2 is an illustration of a vehicle sports rack 100 coupled to a vehicle 124 and carrying a bicycle 126, according to an embodiment. Referring to FIGS. 1 and 2, the hitch bar 112 of the vehicle sports rack 100 has been inserted in and coupled to a trailer hitch receiver 127 of the vehicle 124. The hitch bar 112 can be coupled to the trailer hitch receiver 127 by bolts and pins or other common fastening configurations, as will be described in more detail below.

The front wheel 128 of the bicycle 126 is positioned in one of the C-hoops 106. When the front wheel 128 is positioned in the C-hoop 106, the front wheel 128 rests at a non-vertical angle. The front wheel 128 rests on the upper horizontal support member 104. The front wheel 128 is also in contact with one or more angled support members 108. The bicycle 126 is suspended vertically. The rear wheel 129 rests against the lower horizontal support member 110. When describing how the front and the rear wheels 128, 129 rest on or are supported by various support members 104, 108, 110, it is understood that the tires may actually be in contact with the various support members 104, 108, 110.

The post 102 is in the transport position in which the post 102 extends substantially perpendicularly from the hitch bar 112.

While FIG. 2 shows a single bicycle 126 carried by the vehicle sports rack 100, in practice, the vehicle sports rack 100 may be configured carry plural bicycles 126. In particular, the vehicle sports rack 100 may carry a respective bicycle 126 corresponding to each C-hoop 106. Accordingly, each C-hoop 106 may receive a front wheel 128 of a respective bicycle 126.

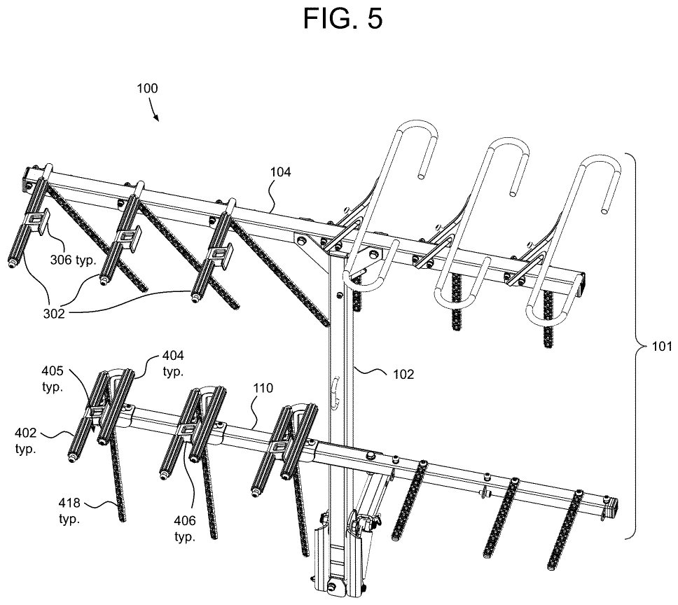

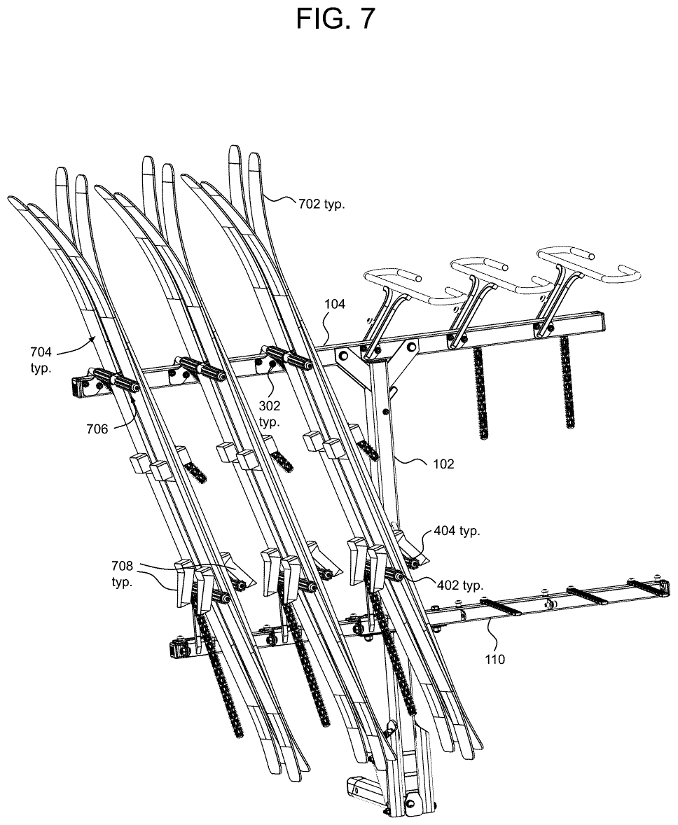

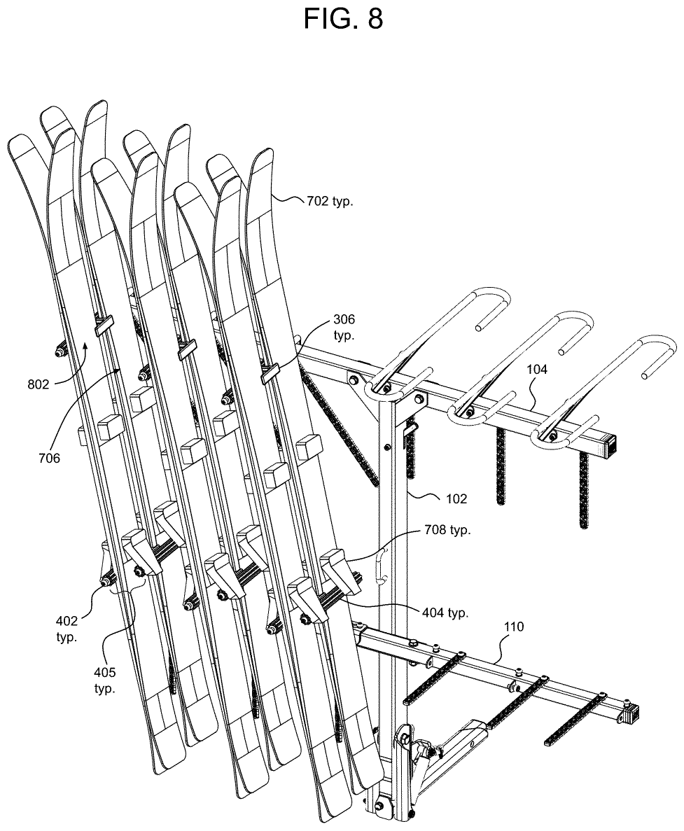

FIG. 3 is a diagram 300 showing a support beam 302 including an edge support 306, according to an embodiment. The vehicle sports rack 100 (see FIGS. 1, 2, and 5, for example) includes a ski and snowboard mounting apparatus including a beam 302 supported by a vehicle rack structure 101. Referring to FIGS. 3, 4, 7, 8, and 10, the beam 302 has a support surface 308 configured to support a base or top surface 704, 1004 of at least one ski 702 and/or snowboard 1002.

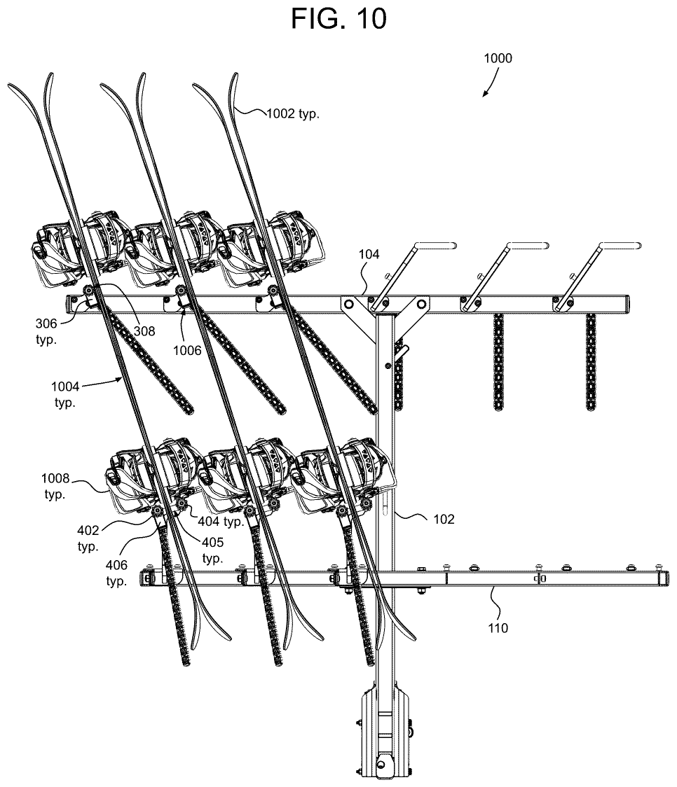

An edge support 306 extends away from the beam support surface 308 to lie adjacent to an edge 706 of the at least one ski 702 to provide support for preventing the at least one ski 702 from translating (sideways) along the support surface 308 of the beam 302. The edge support 306 may be rotatably coupled to the beam 302, such that the edge support 306 is deployable in a first position protruding from the beam support surface 308 (see 300, 400) and adjacent to the edge 706 of the at least one ski 702. The edge support 306 may alternatively be deployable in a second position rotated away from the beam support surface 308 to not protrude from the beam support surface 308. For example, referring to FIG. 10, see the edge support 306 rotated into a position 1006 that extends away from the beam 302 in a direction that allows a snowboard 1002 surface 1004 to lie adjacent to the support surface 308 spanning the location of the edge support 306.

The edge support 306 may include a laterally extended portion 316, extending in a direction generally parallel to the beam 302, wider than a ski edge 706 contact surface 317 of the edge support 306 and configured to extend at least partially across an opposite surface 802 of the at least one ski 702 away from the beam support surface 308. The edge support 306 may be maintained adjacent to the edge 706 of the at least one ski 702 by the laterally extended portion 316 of the edge support 306, which resists rotation because of being held in place by the ski 702.

In another embodiment, the edge support 306 includes a latch (not shown) configured to hold the edge support 306 in a selected position relative to the beam 302 and prevent the edge support 306 from rotating away from the support surface 308 of the beam 302. According to another embodiment, the edge support 306 may be selectively coupled to the beam 302 to extend away from the beam support surface 308. The edge support 306 may be configured to be selectively coupled to the beam 302 by a human hand and without the use of a tool.

According to an embodiment, the edge support 306 may be deformably coupled to either extend away from the beam support surface 308 into adjacency with the at least one ski edge 706, or to extend away from the beam support surface 308 to a different side of the beam 302 to not extend into adjacency with the at least one ski edge 706.

The support beam 302 may include a soft covering configured to preserve a finish of a ski surface 704 adjacent to the beam support surface 308.

The rack structure 101 may include a roof rack. The rack structure 101 may include a tow bar rack.

The support beam 302 may extend parallel to a vehicle direction of travel, such as with a typical tow bar rack, for example. The support beam 302 may extend perpendicular to a vehicle direction of travel, such as with a typical roof rack, for example.

According to an embodiment, a strap 318 may be configured, when fastened, to hold the at least one ski or at least one snowboard against the support surface 308 of the support beam 302. The support beam 302 may include an end knob 320, the end knob 320 being configured to fit through an aperture 322 formed in the strap 318.

A fitting 310 may be fixedly coupled to the support beam 302 and configured to couple the support beam 302 to an upper horizontal support member 104.

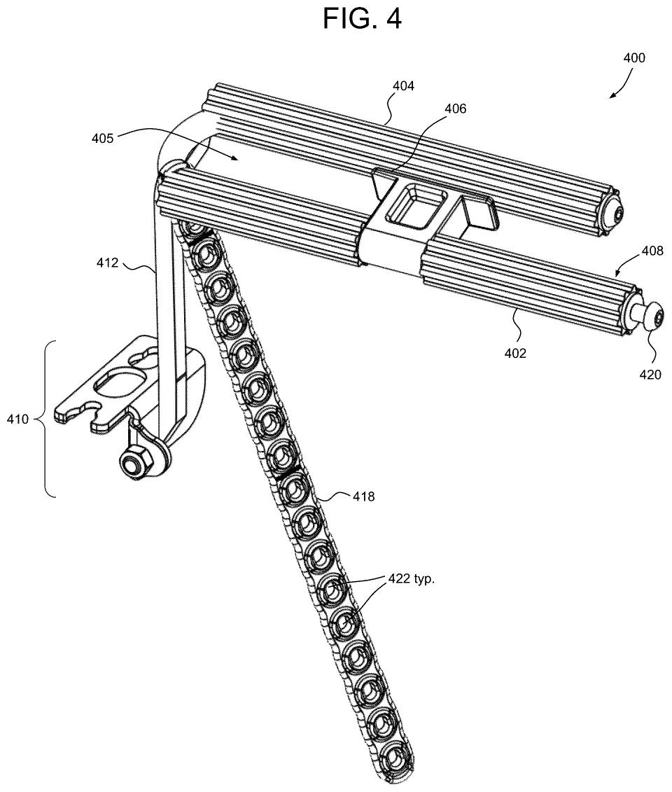

FIG. 4 is a diagram of a lower assembly 400 showing a support beam 402 and edge support, with an additional clamp beam 402 configured to hold a different portion of at least one ski against a support surface 408 of the support beam 402, according to an embodiment.

Referring to FIGS. 1-5, according to an embodiment, the second support beam 402 may be coupled to the vehicle rack structure 101. A platen 404 may be configured to form a gap 405 with the second support beam 402, the second support beam 402 and platen 404 being spaced to prevent passage of at least one ski binding 708 and/or a snowboard binding 1008 through the gap 405. The support beam 302 may be coupled to an upper support member 104, the upper support member 104 being operatively coupled to a post 102. The second support beam 402 may be coupled to a lower support member 110, the lower support member 110 being operatively coupled to the post 102.

A second edge support 406 may be moveably coupled to the second support beam 402. The second support beam 402 and second edge support 406 may consist essentially of structures identical to the support beam 302 and edge support 306.

A second edge support 406 may extend away from a support surface 408 of the second beam 402. According to an embodiment, the second beam 402 and the platen 404 form the gap 405 configured to support the at least one ski 702 or the at least one snowboard 1002 vertically, by preventing the binding 708, 1008 from sliding through the gap 405.

A second strap 418 may be configured, when fastened, to hold the at least one ski 702 or at least one snowboard 1002 against the support surface 408 of the second support beam 402. The second support beam 402 may include a second end knob 420, the second end knob 420 being configured to fit through an aperture 422 formed in the second strap 418.

A fitting 410 may be fixedly coupled to the second support beam 402 and configured to couple the second support beam 402 to a lower horizontal support member 110. The fitting 410 may include a stand-off 412 configured to position the second support beam 402 and platen 404 above the lower horizontal support member 110.

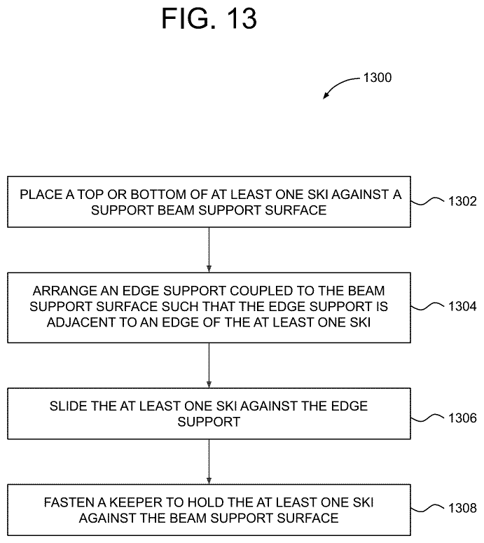

FIG. 13 is a flow chart showing a method 1300 for coupling at least one ski with a support surface of a support beam to a vehicle rack for transport of the at least one ski, according to an embodiment. The method 1300 includes step 1302 placing a surface of at least one ski against a support surface of a support beam, wherein the support beam is operatively coupled to a vehicle rack. In step 1304, an edge support coupled to the beam support surface is arranged at a substantially right angle to the beam support surface such that the edge support is adjacent to an edge of the at least one ski. Step 1306 includes fastening a keeper to hold the at least one ski against the beam support surface while the vehicle is driven. The edge support is configured to prevent the at least one ski from sliding sideways along the beam support surface.

In step 1304, arranging the edge support may include rotating the edge support to protrude from the beam support surface. Arranging the edge support, in step 1304, may include rotating the edge support to cause a laterally extending portion of the edge support to extend from the beam support surface above a plane of the at least one ski in opposition to the beam support surface. The method 1300 may further include, in step 1306, sliding the at least one ski against the edge support and under the laterally extending portion of the edge support. The edge support is prevented from rotating away from the edge of the at least one ski by the laterally extending portion.

Arranging the edge support, in step 1304, may, according to an embodiment, include rotating the edge support to cause a latch to hold the edge support in position for adjacency with the at least one ski edge. Causing the latch to hold the edge support may include operating a detent mechanism coupling the edge support to the support beam to cause the edge support to protrude away from the beam support surface and into position adjacent to the edge of the at least one ski according to a mechanical detent.

Arranging the edge support, in step 1304, at a substantially right angle to the beam support surface such that the edge support is adjacent to an edge of the at least one ski may include snapping the edge support onto the support beam to cause the edge support to be held in adjacency with the at least one ski edge. Snapping the edge support onto the support beam may include elastically deforming the edge support.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

What is claimed is:

1. As part of a sports rack for a vehicle, a ski and snowboard mount comprises:
a support beam supported by a vehicle rack structure, the support beam having a support surface configured to support a surface of at least one ski or snowboard; and
an edge support extending away from the beam support surface to protrude adjacent to an edge of the at least one ski to prevent the at least one ski from translating sideways along the support surface of the support beam.

2. The ski and snowboard mount of claim 1, wherein the edge support is rotatably coupled to the support beam, such that the edge support is deployable in a first position rotated to protrude from the support beam support surface and adjacent to the edge of the at least one ski; and
a second position rotated away from the support beam support surface to not protrude from the support beam support surface.

3. The ski and snowboard mount of claim 2, wherein the edge support includes a laterally extended portion, wider than an edge contact surface of the edge support and configured to extend at least partially across an opposite surface of the at least one ski away from the support beam support surface;
whereby the edge support is maintained adjacent to the edge of the at least one ski by the laterally extended portion.

4. The ski and snowboard mount of claim 2, wherein the edge support includes a latch configured to hold the edge support in a selected position relative to the support beam and prevent the edge support from rotating away from the support surface of the support beam.

5. The ski and snowboard mount of claim 1, wherein the edge support is selectively coupled to the support beam to extend away from the support beam support surface.

6. The ski and snowboard mount of claim 5, wherein the edge support is configured to be selectively coupled to the support beam by a human hand and without the use of a tool.

7. The ski and snowboard mount of claim 5, wherein the edge support is deformably coupled to either extend away from the support beam support surface into adjacency with the at least one ski edge, or to not extend away from the beam support surface to not extend into adjacency with the at least one ski edge.

8. The ski and snowboard mount of claim 1, wherein the support beam includes a soft covering configured to preserve a finish of a ski surface adjacent to the support beam support surface.

9. The ski and snowboard mount of claim 1, wherein rack structure includes a roof rack.

10. The ski and snowboard mount of claim 1, wherein the rack structure includes a tow bar rack.

11. The ski and snowboard mount of claim 1, wherein the support beam extends parallel to a vehicle direction of travel.

12. The ski and snowboard mount of claim 1, wherein the support beam extends perpendicular to a vehicle direction of travel.

13. The ski and snowboard mount of claim 1, further comprising:
a strap configured, when fastened, to hold the at least one ski or at least one snowboard against the support surface of the support beam.

14. The ski and snowboard mount of claim 13, wherein the support beam includes an end knob, the end knob being configured to fit through an aperture formed in the strap.

15. The ski and snowboard mount of claim 1, further comprising:
a fitting fixedly coupled to the support beam and configured to couple the support beam to an upper horizontal support member of the vehicle rack.

16. The ski and snowboard mount of claim 1, further comprising:
a second support beam coupled to the vehicle rack structure; and
a platen configured to form a gap with the second support beam, the second support beam and platen being spaced to prevent passage of at least one ski binding and/or a snowboard binding through the gap.

17. The ski and snowboard mount of claim 16, wherein the support beam is coupled to an upper support member, the upper support member being operatively coupled to a post; and
wherein the second support beam is coupled to a lower support member, the lower support member being operatively coupled to the post.

18. The ski and snowboard mount of claim 16, further comprising:
a second edge support moveably coupled to the second support beam.

19. The ski and snowboard mount of claim 16, wherein the second support beam and second edge support consist essentially of structures identical to the support beam and edge support.

20. The ski and snowboard mount of claim 16, further comprising:
a second edge support extending away from a support surface of the second beam.

21. The ski and snowboard mount of claim 16, wherein the second beam and the platen form the gap configured to support the at least one ski or the at least one snowboard vertically, by preventing the binding from sliding through the gap.

22. The ski and snowboard mount of claim 16, further comprising:
a second strap configured, when fastened, to hold the at least one ski or at least one snowboard against the support surface of the second support beam.

23. The ski and snowboard mount of claim 22, wherein the second support beam includes a second end knob, the second end knob being configured to fit through an aperture formed in the second strap.

24. The ski and snowboard mount of claim 16, further comprising:
a fitting fixedly coupled to the second support beam and configured to couple the second support beam to a lower horizontal support member.

25. The ski and snowboard mount of claim 24, wherein the fitting includes a stand-off configured to position the second support beam and platen above the lower horizontal support member.

26. A method for coupling at least one ski with a support surface of a support beam to a vehicle rack for transport of the at least one ski, comprising the steps of:
placing at least one ski against a support surface of a support beam and a surface of the at least one ski, wherein the support beam is operatively coupled to a vehicle rack;
arranging an edge support coupled to the beam support surface at a substantially right angle to the beam support surface such that the edge support is adjacent to an edge of the at least one ski; and
fastening a keeper to hold the at least one ski against the beam support surface while the vehicle is driven;
whereby the edge support is configured to prevent the at least one ski from sliding sideways along the beam support surface.

27. The method for coupling at least one ski with a support surface of a support beam to a vehicle rack for transport of the at least one ski of claim 26, wherein arranging the edge support includes rotating the edge support to protrude from the beam support surface.

28. The method for coupling at least one ski with a support surface of a support beam to a vehicle rack for transport of the at least one ski of claim 26, wherein arranging the edge support includes rotating the edge support to cause a laterally extending portion of the edge support to extend from the beam support surface above a plane of the at least one ski in opposition to the beam support surface;
further comprising:
sliding the at least one ski against the edge support and under the laterally extending portion of the edge support;
wherein the edge support is prevented from rotating away from the edge of the at least one ski by the laterally extending portion.

29. The method for coupling at least one ski with a support surface of a support beam to a vehicle rack for transport of the at least one ski of claim 26, wherein selectively coupling the edge support includes rotating the edge support to cause a latch to hold the edge support in position for adjacency with the at least one ski edge.

30. The method for coupling at least one ski with a support surface of a support beam to a vehicle rack for transport of the at least one ski of claim 29, wherein causing the latch to hold the edge support includes operating a detent mechanism coupling the edge support to the support beam to cause the edge support to protrude away from the beam support surface and into position adjacent to the edge of the at least one ski according to a mechanical detent.

31. The method for coupling at least one ski with a support surface of a support beam to a vehicle rack for transport of the at least one ski of claim 26, wherein selectively coupling the edge support at a substantially right angle to the beam support surface such that the edge support is adjacent to an edge of the at least one ski includes:
snapping the edge support onto the support beam to cause the edge support to be held in adjacency with the at least one ski edge.

32. The method for coupling at least one ski with a support surface of a support beam to a vehicle rack for transport of the at least one ski of claim 31, wherein snapping the edge support onto the support beam includes elastically deforming the edge support.
